(19) United States
(12) Patent Application Publication
(10) Pub. No.: US 2010/0149459 A1
(43) Pub. Date: Jun. 17, 2010

(54) VIEW ANGLE CONTROL ELEMENT AND DISPLAY DEVICE PROVIDED WITH THE SAME

(76) Inventors: Koji Yabuta, Osaka-shi (JP); Tomoo Takatani, Osaka-shi (JP); Hiroshi Fukushima, Osaka-shi (JP)

Correspondence Address: NIXON & VANDERHYE, PC, 901 NORTH GLEBE ROAD, 11TH FLOOR, ARLINGTON, VA, 22203, US

(21) Appl. No.: 12/600,919

(22) PCT Filed: Jul. 7, 2008
(86) PCT No.: PCT/JP2008/062282

§ 371 Date: Nov. 19, 2009

(30) Foreign Application Priority Data
Jul. 9, 2007 (JP) 2007-180125

(51) Int. Cl. G02F 1/1347; G02F 1/13

(52) U.S. Cl. 349/74; 349/193

(57) ABSTRACT

A view angle control element capable of limiting a view angle without degrading image quality (front quality) when seen from a front side and a display device provided with the view angle control element are provided. A liquid crystal display device (1) includes a liquid crystal panel (10), and a view angle control film (20) that controls a view angle of the liquid crystal panel (10). The view angle control film (20) is a laminated film including at least a liquid crystal film (21) and a linearly polarizing plate (22). In the liquid crystal film (21), liquid crystal molecules are solidified while being aligned with major axes tilted in a predetermined azimuth angle direction from a normal direction of a film surface. The linearly polarizing plate (22) of the view angle control film (20) and the linearly polarizing plate (14) of the liquid crystal panel (10) are placed so that polarization transmission axes thereof cross a major axis direction of the liquid crystal molecules when seen from the normal direction.

### TECHNICAL FIELD

The present invention relates to a view angle control element capable of controlling a view angle and a display device provided with the view angle control element.

### BACKGROUND ART

In general, a display is required to have the largest possible view angle so that a clear image can be seen from any visual angle. Particularly, in a liquid crystal display that is recently diffused widely, liquid crystal has view angle dependence, and hence, various technological developments have been performed with respect to the enlargement of a view angle. However, a smaller view angle, which allows only a user to identify display contents visually, may be convenient depending upon the use environment. In particular, there is a high possibility that a notebook personal computer, a personal digital assistance (PDA), a mobile telephone, or the like is used in a place such as a train or an airplane where an indefinite number of people may be present. In such a use environment, since a user does not want others in the surrounding to see the display contents, it is desirable that a display has a small view angle, considering the security protection, privacy protection, etc. Thus, recently, there is an increasing demand for switching a view angle of one display between a large view angle and a small view angle depending upon the use situation. Such a demand is a problem common to any display as well as a liquid crystal display.

In order to satisfy the above-mentioned demand, the following technique has been proposed: a phase difference control device is provided in addition to a display device displaying an image, and the voltage applied to the phase difference control device is controlled, whereby view angle characteristics are changed (for example, the following Document 1). In Document 1, as a liquid crystal mode used in a liquid crystal display device for controlling a phase difference, a chiral nematic liquid crystal, a homogeneous liquid crystal, a randomly Aligned nematic liquid crystal, and the like are illustrated.

Further, the following configuration also has been disclosed conventionally: a liquid crystal panel for controlling a view angle is provided in an upper portion of a liquid crystal panel for a display, these panels are interposed between two polarizing plates, and the voltage applied to the liquid crystal panel for controlling a view angle is adjusted, whereby a view angle is controlled (for example, Document 2). In Document 2, the liquid crystal mode of the liquid crystal panel for controlling a view angle is a twisted nematic system.

However, according to the configuration using a liquid crystal panel for controlling a view angle as described in Documents 1 and 2, there is a problem that the total thickness of the display device increases. Further, since it is necessary to produce and attach a liquid crystal panel for controlling a view angle, there also is a problem of a high production cost.

Then, as a device for controlling a view angle more easily, compared with the above-mentioned liquid crystal panel for controlling a view angle, a filter generally called a “privacy filter” or the like is known (Documents 3 and 4). The privacy filter described in Document 3 transmits only light in a direction perpendicular to the filter surface. Therefore, when the privacy filter is attached to the screen of a display device, the display on the screen cannot be seen from a lateral direction. The filter described in Document 4 has a configuration in which a film of PET (polyethylene terephthalate) or the like is laminated on a louver film, and controls the direction of transmitted light and a visible angle.

[Document 1] JP 3322197

[Document 2] JP 10(1998)-268251 A

[Document 3] JP 2005-173571 A

[Document 4] “3M Optical Systems Products (view angle adjusting film ‘light control film’)”, [online], Sumitomo 3M Ltd., [searched on Apr. 5, 2007], Internet, (URL: http://www.mmm.co.jp/display/light/index.html)

### DISCLOSURE OF INVENTION

### Problem to be Solved by the Invention

Hereinafter, the configuration of the louver film used in the filter described in Document 4 will be described with reference to FIG. 20. FIG. 20A is a cross-sectional view of the louver film, and FIG. 20B is a plan view of the louver film. As shown in FIGS. 20A and 20B, the louver film 50 has a configuration in which louver light-shielding portions 51 are placed at a predetermined interval between transmission portions 52. Tight incident upon one surface of the louver film 50 has a transmission angle (β in FIG. 20A) for passing through the transmission portions 52 limited by the louver light-shielding portions 51. Thus, the view angle of a display device is limited by attaching the louver film 50 to the screen of the display device.

However, with the above-mentioned conventional louver film, since the transmitted light is limited by the louver light-shielding portions 51, light occurs that is blocked by the louver light-shielding portions 51 and cannot pass through the louver film, which causes a problem of a decrease in brightness of the screen seen from a front side. Further, as is understood from FIG. 20B, a stripe pattern of the louver light-shielding portions 51 can be identified visually, which also causes a problem of degraded image quality.

Further, when a display device has a color filter, in order to prevent the interference between the louver light-shielding portions 51 and the color filter, as shown in FIG. 20B, a louver film is placed so that the stripe pattern of the louver light-shielding portions 51 is inclined with respect to horizontal and vertical directions (x and y directions shown in FIGS. 20A and 20B) of the screen of the display device. The reason for this is as follows: if the stripe pattern of the louver light-shielding portions 51 is parallel to the vertical or horizontal direction of the screen of the display device, moiré fringes occur at a particular period due to the interference between the louver light-shielding portions 51 and the color filter of the display device. However, when the louver film is placed as shown in FIG. 20B, there is a problem that a view angle cannot be controlled to be symmetrical horizontally (or vertically) on the screen.

In view of the above problems, an object of the present invention is to provide a view angle control element capable of controlling a view angle without degrading image quality (front quality) when seen from a front side, and a display device provided with the view angle control element.

### Means for Solving Problem

In order to achieve the above object, a first display device according to the present invention includes an image display device that displays an image and a view angle control element that is laminated on the image display device and controls a view angle of the image display device. The image display device includes a linearly polarizing plate on a side of the view angle control element, and the view angle control element is a laminated film including at least a liquid crystal film, and a linearly polarizing plate laminated on a side of the liquid crystal film opposite to the linearly polarizing plate of the image display device. In the liquid crystal film, liquid crystal molecules are solidified while being aligned with major axes thereof tilted in a predetermined azimuth angle direction from a normal direction of a surface of the liquid crystal film, and a polarization transmission axis of the linearly polarizing plate crosses a major axis direction of the liquid crystal molecules when seen from the normal direction of the view angle control element.

In order to achieve the above object, a second display device according to the present invention includes an image display device that displays an image, and a view angle control element that is laminated on the image display device and controls a view angle of the image display device. The image display device includes a linearly polarizing plate on a side of the view angle control element, and the view angle control element is a laminated film including at least a phase difference plate whose refractive index satisfies nx=ny>nz, a pair of ¼ wavelength phase difference plates placed so as to sandwich the phase difference plate, and a linearly polarizing plate that is laminated on a surface of the ¼ wavelength phase difference plate that is not opposed to the image display device among the pair of ¼ wavelength phase difference plates.

In order to achieve the above object, a first view angle control element according to the present invention is laminated on an image display device having a linearly polarizing plate and controls a view angle of the image display device. The view angle control element is a laminated film including at least a liquid crystal film and a linearly polarizing plate laminated on a side of the liquid crystal film opposite to the linearly polarizing plate of the image display device. In the liquid crystal film, liquid crystal molecules are solidified while being aligned with major axes thereof tilted in a predetermined azimuth angle direction from a normal direction of a surface of the liquid crystal film, and a polarization transmission axis of the linearly polarizing plate crosses a major axis direction of the liquid crystal molecules when seen from the normal direction of the view angle control element.

In order to achieve the above object, a second view angle control element according to the present invention is laminated on an image display device having a linearly polarizing plate and controls a view angle of the image display device. The view angle control element is a laminated film including at least a phase difference plate whose refractive index satisfies nx=ny>nz, a pair of ¼ wavelength phase difference plates placed so as to sandwich the phase difference plate, and a linearly polarizing plate that is laminated on a surface of the ¼ wavelength phase difference plate that is not opposed to the image display device among the pair of ¼ wavelength phase difference plates.

### Effects of the Invention

According to the present invention, a view angle control element capable of controlling a view angle without degrading image quality (front quality) when seen from a front side, and a display device provided with the view angle control element can be provided.

### BRIEF DESCRIPTION OF DRAWINGS

FIG. 1 is a schematic cross-sectional view showing a schematic configuration of a liquid crystal display device according to Embodiment 1 of the present invention.

FIG. 2 is a schematic cross-sectional view showing a schematic configuration of one modified example of the liquid crystal display device according to Embodiment 1.

FIG. 3A is a cross-sectional view in an xz-plane of a view angle control film according to Embodiment 1, and FIG. 3B is a cross-sectional view in a yz-plane.

FIG. 4 is a schematic view showing a relationship between the alignment direction of liquid crystal molecules in the view angle control film according to Embodiment 1 and the polarization transmission axis of a linearly polarizing plate.

FIG. 5 is a schematic view showing the definition of a view angle with respect to the view angle control film.

FIG. 6 is a schematic cross-sectional view showing a schematic configuration of another modified example of the liquid crystal display device according to Embodiment 1.

FIG. 7 is an explanatory view showing the comparison between the effects of the liquid crystal display device according to Embodiment 1 and the effects in comparative examples.

FIGS. 8A and 8B are schematic cross-sectional views showing another example of a liquid crystal film used in the view angle control film according to Embodiment 1.

FIG. 9 is a schematic cross-sectional view schematically showing one configuration example of a liquid crystal display device according to Embodiment 2 of the present invention.

FIG. 10 is a schematic view showing the arrangement relationship among optical axes in a view angle control film of the liquid crystal display device shown in FIG. 9.

FIG. 11 is a schematic cross-sectional view schematically showing another configuration example of the liquid crystal display device according to Embodiment 2 of the present invention.

FIG. 12 is a schematic view showing the arrangement relationship among optical axes in a view angle control film of the liquid crystal display device shown in FIG. 11.

FIG. 13 is a schematic cross-sectional view schematically showing still another configuration example of the liquid crystal display device according to Embodiment 2 of the present invention.

FIG. 14 is a schematic view showing the arrangement relationship among optical axes in a view angle control film of the liquid crystal display device shown in FIG. 13.

FIG. 15 is a schematic cross-sectional view schematically showing still another configuration of the liquid crystal display device according to Embodiment 2 of the present invention.

FIG. 16 is a schematic view showing the arrangement relationship among optical axes in a view angle control film of the liquid crystal display device shown in FIG. 15.

FIG. 17A-17D are charts respectively showing the optical characteristics of the liquid crystal display devices shown in FIGS. 9, 11, 13, and 15.

FIG. 18 is a schematic cross-sectional view showing a schematic configuration of one modified example of the liquid crystal display device according to Embodiment 2.

FIG. 19 is a schematic cross-sectional view showing a schematic configuration of another modified example of the liquid crystal display device according to Embodiment 2.

FIG. 20A is a cross-sectional view of a conventional louver film, and FIG. 20B is a plan view of the conventional louver film.

### DESCRIPTION OF THE INVENTION

A first display device of the present invention includes an image display device that displays an image and a view angle control element that is laminated on the image display device and controls a view angle of the image display device. The image display device includes a linearly polarizing plate on a side of the view angle control element, and the view angle control element is a laminated film including at least a liquid crystal film, and a linearly polarizing plate laminated on a side of the liquid crystal film opposite to the linearly polarizing plate of the image display device. In the liquid crystal film, liquid crystal molecules are solidified while being aligned with major axes thereof tilted in a predetermined azimuth angle direction from a normal direction of a surface of the liquid crystal film, and a polarization transmission axis of the linearly polarizing plate crosses a major axis direction of the liquid crystal molecules when seen from the normal direction of the view angle control element.

The above-mentioned first display device may have a configuration in which tilt angles of the major axes of the liquid crystal molecules are constant and may have a configuration in which the liquid crystal molecules are solidified in a hybrid alignment state. The liquid crystal may be nematic liquid crystal or discotic liquid crystal.

In the above-mentioned first display device, the image display device is, for example, a transmission type or semi-transmission type liquid crystal display device having a liquid crystal layer. In this configuration, the view angle control element may be placed on a viewer side with respect to the liquid crystal display device, or the view angle control element may be placed on a back surface side of a liquid crystal layer of the liquid crystal display device with respect to a viewer.

A second display device of the present invention includes an image display device that displays an image, and a view angle control element that is laminated on the image display device and controls a view angle of the image display device. The image display device includes a linearly polarizing plate on a side of the view angle control element, and the view angle control element is a laminated film including at least a phase difference plate whose refractive index satisfies nx=ny>nz, a pair of ¼ wavelength phase difference plates placed so as to sandwich the phase difference plate, and a linearly polarizing plate that is laminated on a surface of the ¼ wavelength phase difference plate that is not opposed to the image display device among the pair of ¼ wavelength phase difference plates.

It is preferred that the above-mentioned second display device further includes a ½ wavelength phase difference plate in at least one portion between the ¼ wavelength phase difference plate and the linearly polarizing plate.

A first view angle control element of the present invention is laminated on an image display device having a linearly polarizing plate and controls a view angle of the image display device. The view angle control element is a laminated film including at least a liquid crystal film and a linearly polarizing plate laminated on a side of the liquid crystal film opposite to the linearly polarizing plate of the image display device. In the liquid crystal film, liquid crystal molecules are solidified while being aligned with major axes thereof tilted in a predetermined azimuth angle direction from a normal direction of a surface of the liquid crystal film, and a polarization transmission axis of the linearly polarizing plate crosses a major axis direction of the liquid crystal molecules when seen from the normal direction of the view angle control element.

A second view angle control element of the present invention is laminated on an image display device having a linearly polarizing plate and controls a view angle of the image display device. The view angle control element is a laminated film including at least a phase difference plate whose refractive index satisfies nx=ny>nz, a pair of ¼ wavelength phase difference plates placed so as to sandwich the phase difference plate, and a linearly polarizing plate that is laminated on a surface of the ¼ wavelength phase difference plate that is not opposed to the image display device among the pair of ¼ wavelength phase difference plates.

Hereinafter, the present invention will be described by way of more specific embodiments with reference to the drawings. Each figure referred to below shows, in a simplified manner, only main members required for illustrating the present invention among the constituent members of the embodiments of the present invention, for the convenience of the description. Therefore, the display device according to the present invention can include any constituent members not shown in each figure referred to in the present specification. Further, the size of each member in each figure does not necessarily express the size of an actual constituent member, the size ratio between members, and the like.

### Embodiment 1

Hereinafter, a liquid crystal display device according to Embodiment 1 of the present invention will be described with reference to the drawings. Herein, as an example of the display device according to the present invention, a configuration in which a liquid crystal display device is provided as an image display device will be illustrated.

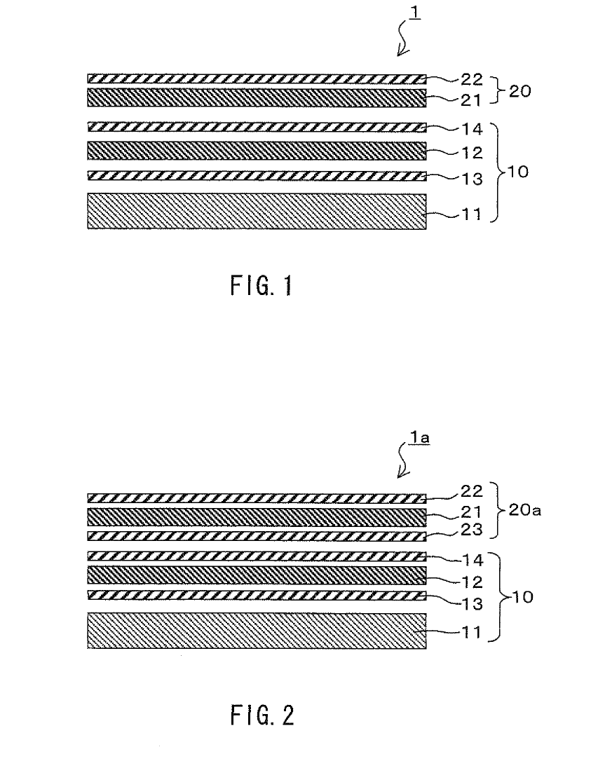

FIG. 1 is a schematic cross-sectional view showing a schematic configuration of a liquid crystal display device 1 according to Embodiment 1 of the present invention. FIG. 1 intends to show the lamination order of main constituent members of the liquid crystal display device 1 according to Embodiment 1, instead of showing an actual cross-sectional configuration.

As shown in FIG. 1, the liquid crystal display device 1 includes a liquid crystal panel 10 (image display device) that displays an image, and a view angle control film 20 (view angle control element) that is placed on a viewer side with respect to the liquid crystal panel 10 and controls the view angle of the liquid crystal panel 10.

In the example shown in FIG. 1, the view angle control film 20 is placed on the viewer side of the liquid crystal panel 10. As the liquid crystal panel 10, any kind of liquid crystal panel can be used, and there is no limit to a liquid crystal mold thereof, a drive system, and the like. The liquid crystal panel 10 may be a monochromatic display panel or a color display panel. In the example shown in FIG. 1, the liquid crystal panel 10 is a transmission type liquid crystal panel having a backlight 11, and may be a semi-transmission type liquid crystal panel or a reflection type liquid crystal panel. When the liquid crystal panel 10 is a reflection type liquid crystal panel, a backlight is not necessary.

As shown in FIG. 1, the liquid crystal panel 10 includes the above-mentioned backlight 11, a liquid crystal cell 12, and a pair of linearly polarizing plates 13, 14 sandwiching the liquid crystal cell 12. The view angle control film 20 is a laminated film composed of a liquid crystal film 21 and a linearly polarizing plate 22. In FIG. 1, although the liquid crystal film 21 and the linearly polarizing plate 22 are shown apart, the liquid crystal film 21 and the linearly polarizing plate 22 actually are bonded to each other with an adhesive or the like.

In the configuration of FIG. 1, the liquid crystal panel 10 further changes the polarization state of linearly polarized light that is output from the backlight 11 and is incident upon the liquid crystal cell 12 through the linearly polarizing plate 13 (incident-side polarizing plate) in accordance with the voltage applied to a liquid crystal layer in the liquid crystal cell 12. This allows only a polarized light component, which is matched with the polarization transmission axis of the linearly polarizing plate 14 (output-side polarizing plate) of the light having passed through the liquid crystal cell 12, to pass through the linearly polarizing plate 14 and be output to the viewer side. Thus, a desired image can be displayed by driving each pixel of the liquid crystal panel 10 in accordance with a gray-scale to be displayed in a known embodiment.

A liquid crystal display device 1a provided with a view angle control film 20a in which the liquid crystal film 21 is sandwiched between a pair of linearly polarizing plates 22, 23 as shown in FIG. 2, in place of the view angle control film 20 shown in FIG. 1, also is one embodiment of the present invention. It should be noted that the configuration in which one linearly polarizing plate 14 is provided between the liquid crystal cell 12 and the liquid crystal film 21 as in the liquid crystal display device 1 shown in FIG. 1 is more advantageous in terms of the total thickness of the device, production cost, transmittance, and the like, since one polarizing plate may be omitted from the configuration shown in FIG. 2.

The liquid crystal film 21 of the view angle control film 20 is a film in which liquid crystal molecules 21a are solidified while being aligned in the same direction, and functions as an inclined phase difference plate. As the material for the liquid crystal film 21, for example, a UV-curable liquid crystal polymer containing a nematic liquid crystal material is used. The polymer is irradiated with UV light while being supplied with a predetermined electric field, whereby liquid crystal can be formed into a film while the liquid crystal molecules 21a are aligned in the same direction, as described above.

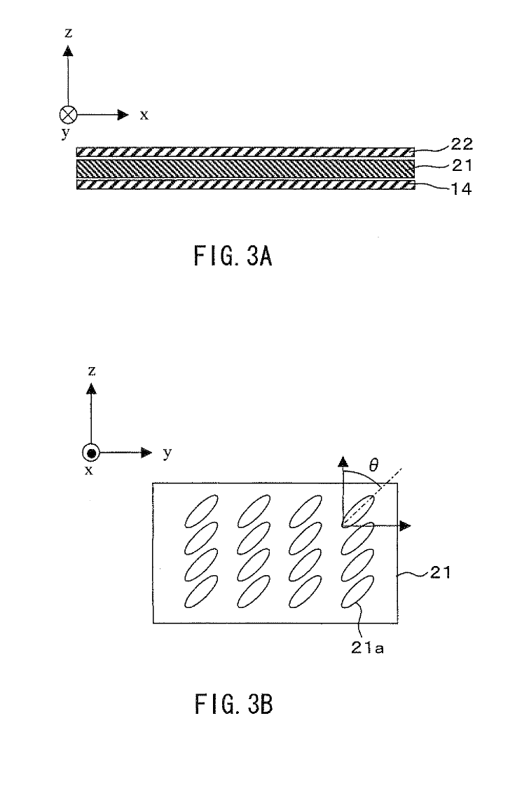

The liquid crystal molecules 21a in the liquid crystal film 21 are aligned uniaxially As shown in FIG. 3A, assuming that the thickness direction of the liquid crystal film 21 is a z-axis direction, and the plane parallel to the film surface is an xy-plane, all the liquid crystal molecules 21a are aligned so as to be tilted in a positive direction of a y-axis so that the major axis direction thereof forms a predetermined angle θ (about 45°) with respect to the z-axis in a yz-plane, as shown in FIG. 3B. In FIG. 3B, although the liquid crystal molecules 21a are shown in a football shape, the shape of the liquid crystal molecules 21a is not limited thereto.

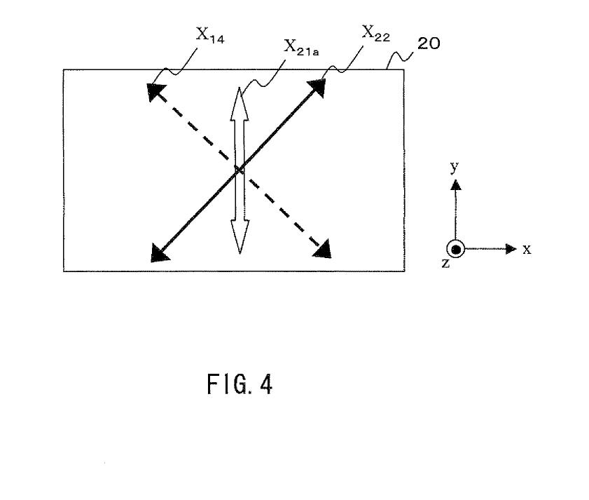

FIG. 4 is a schematic view showing a relationship between the alignment direction of the liquid crystal molecules 21a and the polarization transmission axes of the linearly polarizing plates 22, 23. X₂₁ₐ shown in FIG. 4 indicates a major axis direction of the liquid crystal molecules 21a (hereinafter, referred to as an alignment direction of the liquid crystal molecules 21a) when the view angle control film 20 is seen from a z-direction. X₂₂ and X₁₄ shown in FIG. 4 indicate polarization transmission axes of the linearly polarizing plate 22 and the linearly polarizing plate 14. As shown in FIG. 4, in the view angle control film. 20, the linearly polarizing plate 22 and the linearly polarizing plate 14 are placed so that the polarization transmission axes X₂₂, X₁₄ are substantially perpendicular to each other. The crossing angle between the polarization transmission axes X₂₂ and X₁₄ may be in a range of 80° to 100°. The liquid crystal film 21 is placed so that an angle formed by the alignment direction X₂₁ₐ of the liquid crystal molecules 21a and the polarization transmission axes X₂₂, X₁₄ is about 45°.

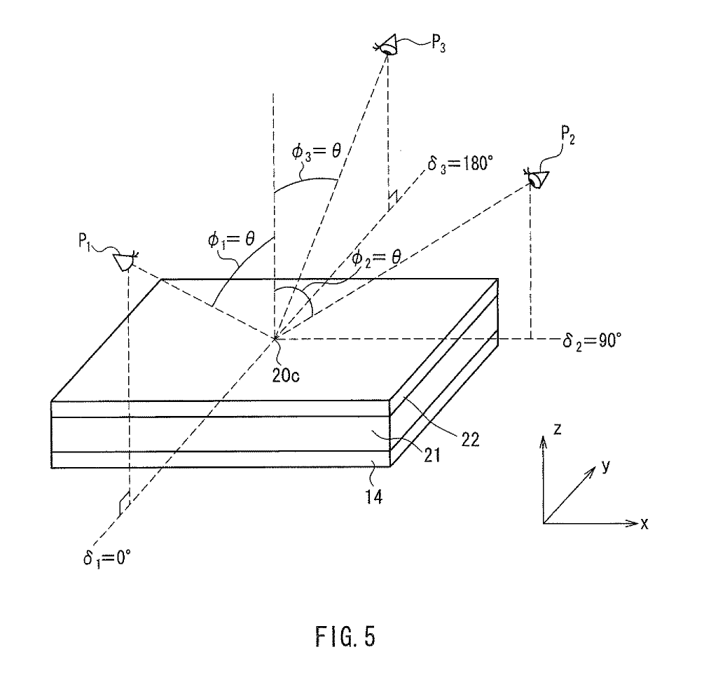

The principle will be described in which a view angle is controlled in the view angle control film 20 where the liquid crystal film 21 and the linearly polarizing plate 22 are placed as described above. In the following description, a view angle from any eyepoint with respect to the view angle control film 20 is represented by an azimuth angle δ and a polar angle φ based on a center 20c of the view angle control film 20. FIG. 5 shows visual angles from three eyepoints P₁ to P₃ with respect to the view angle control film 20. FIG. 5 also shows a relationship with the xyz-coordinate system shown in FIGS. 3A and 3B. As shown in FIG. 5, the azimuth angle δ is a rotation angle of a line that connects the leg of a normal from an eyepoint to a plane including the surface of the view angle control film 20 to the center 20c of the view angle control film 20. In the example shown in FIG. 5, it is assumed that the azimuth angle δ increases clockwise when seen from an upper side of the view angle control film 20 in the normal direction, with an azimuth angle δ₁ in the direction of the eyepoint P₁ being a reference (0°). An azimuth angle δ₂ of the eyepoint P₂ is 90°, and an azimuth angle δ₃ of an eyepoint P₃ is 180°. The polar angle φ is an angle formed by a straight line connecting the center 20c of the view angle control film 20 to an eyepoint, and a normal (z-axis) to the view angle control film 20. In FIG. 5, the polar angles φ₁ to φ₃ at the eyepoints P₁ to P₃ are all θ shown in FIG. 3B. As shown in FIG. 5, the y-axis shown in FIGS. 3A and 3B is matched with the direction from the azimuth angle 0° to 180°, and the x-axis is matched with the direction from the azimuth angle 270° to 180°.

When the view angle control film 20 is observed from a front direction (the normal direction, i.e., the z-axis direction), the liquid crystal film 21 functions as a ¼ wavelength plate with respect to light passing through the film in the normal direction. As a result, linearly polarized light that is incident upon the liquid crystal film 21 perpendicularly from the liquid crystal panel 10 through the linearly polarizing plate 14 becomes circularly polarized light by passing through the liquid crystal film 21 that functions as a ¼ wavelength plate, and then, a linearly polarized light component having passed through the linearly polarizing plate 22 is output to the viewer side. Thus, when observing the view angle control panel 20 from the front direction, the viewer can identify the display contents of the liquid crystal panel 20 visually.

On the other hand, when the view angle control film 20 is seen from the eyepoint P₂, light cannot pass therethrough since the birefringence decreases as the polar angle φ₂ increases. Thus, in this case, the light output from the liquid crystal panel 10 is blocked completely by the view angle control film 20, and the screen looks dark to the viewer. The same applies to the case where the view angle control film 20 is seen from a visual angle at an azimuth angle of 270° and a polar angle of θ or more. In other words, the liquid crystal film 21 is designed so as to function substantially as a phase difference plate having a phase difference of λ/2 when the liquid crystal film 21 is seen from a visual angle at an azimuth angle of 90° or 270° and a polar angle of 45° or more. Herein, λ indicates a main wavelength component that contributes to the display of the liquid crystal panel 10. λ is, for example, in a range of 550 nm to 589 nm and is not limited thereto. Further, the above-mentioned “substantially” means that the corresponding effects are exhibited in a range of ±10%.

When the view angle control film 20 is seen from the eyepoint P₁, the liquid crystal film 21 functions as a ½ wavelength plate. Thus, the light output from the liquid crystal film 21 passes through the linearly polarizing plate 22 to be identified visually by a viewer.

Further, when the view angle control film 20 is seen from the eyepoint P₃, the liquid crystal film 21 does not have birefringence with respect to light passing in this direction. Thus, the light output from the liquid crystal film 21 cannot pass through the linearly polarizing plate 22 and is not identified visually by a viewer.

The liquid crystal film 21 can be created by applying a liquid crystal polymer to a base film and heating it, thereby increasing the tilt of liquid crystal molecules on a farther side from a base film interface. As the liquid crystal film 21, for example, Wide View Film (trade name) produced by Fuji Photo Film Co., Ltd., or a film described in JP 6(1994)-222213 A can be used.

The view angle control film 20 according to the present embodiment can be attached to the surface of the liquid crystal panel 1 easily with an adhesive or the like. Therefore, compared with the configurations provided with a liquid crystal panel for controlling a view angle disclosed by Documents 1 and 2, the view angle control film 20 has advantages of high productivity and low production cost.

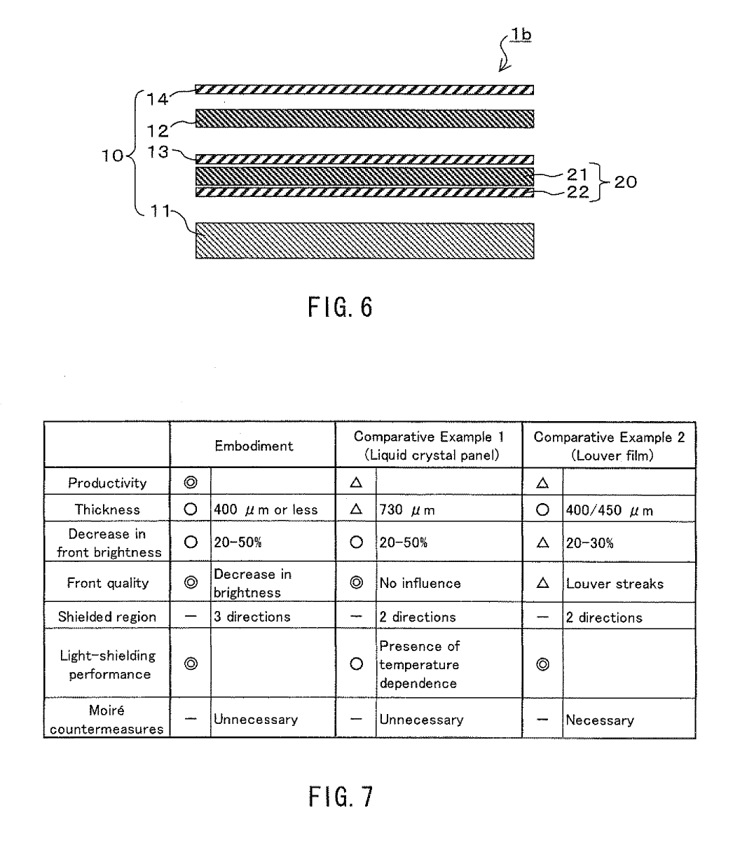

In the above description, a configuration is illustrated in which the view angle control film 20 is placed on the viewer side with respect to the liquid crystal panel 10. However, as shown in FIG. 6, a liquid crystal display device 1b, in which the view angle control film 20 is provided on a back surface side of the liquid crystal cell 12 of the liquid crystal panel 10, also is one modified example of the liquid crystal display device 1 shown in FIG. 1, and has the same effects as those of the liquid crystal display device 1. In the liquid crystal display device 1b shown in FIG. 6, the view angle control film 20 having the linearly polarizing plate 22 and the liquid crystal film 21 is placed between the backlight 11 that is a light source of the liquid crystal panel 10 and the liquid crystal cell 12.

As described above, in the liquid crystal display device according to the present embodiment, due to the presence of the view angle control film 20 controlling the view angle of the liquid crystal panel 10, a small view angle state can be realized, at which the display of the liquid crystal panel 10 is not seen from an oblique direction, without degrading the display quality obtained when seen from a front side. Herein, FIG. 7 shows the effects of the liquid crystal display device according to the present embodiment, compared with a conventional display device (referred to as Comparative Example 1) realizing a small view angle state by the liquid crystal panel for controlling a view angle as described in Documents 1, 2 and a conventional display device (referred to as Comparative Example 2) realizing a small view angle state by the louver film described in Document 4. “Δ” in a table shown in FIG. 7 indicates that the performance and the like are relatively poor; “◯” indicates that the performance and the like are relatively good; and “⊚” indicates that the performance and the like are relatively particularly excellent.

As shown in FIG. 7, the liquid crystal display device according to the present embodiment is most excellent in terms of productivity. This is because the display device of Comparative Example 1 requires the complicated steps of producing and attaching a liquid crystal panel since the display device uses the liquid crystal panel for controlling a view angle. Further, the louver film in Comparative Example 2 includes the complicated step of forming louver light-shielding portions, whereas the view angle control film 20 in the present embodiment does not particularly include complicated steps.

The total thickness of the display device in Comparative Example 1 is largest, and those in Comparative Example 2 and the present embodiment are smaller than that in Comparative Example 1. The view angle control film 20 of the present embodiment is composed of only the liquid crystal film 21 and the polarizing plate 22, so that the view angle control film 20 is advantageous in terms of the capability of being reduced in thickness, compared with the louver film that is difficult to be thinned. The view angle control characteristics (light-shielding property) of the louver film are determined by the thickness of the film and the pitch of the louver light-shielding portions 51. Therefore, in order to reduce the thickness of the louver film while keeping the light-shielding property, high precision processing that reduces the pitch of the louver light-shielding portions 51 is required. Therefore, the louver film is required to have a thickness to some degree, which limits the reduction in thickness.

In FIG. 7, a decrease ratio of front brightness refers to a brightness decrease ratio, compared with the case where there is not a liquid crystal panel or film for controlling a view angle, and the decrease ratio in Comparative Example 1 and the present embodiment is 20 to 50%, and the decrease ratio in Comparative Example 2 is 20 to 30%, which can be considered to be almost equal.

Regarding the image quality (front quality) when the screen of the display device is seen from a front side, the front quality is degraded due to the streaks of the louver light-shielding portions, as described above, in the louver film of Comparative Example 2. On the other hand, in the view angle control film 20 of the present embodiment, although the front brightness decreases slightly compared with that of Comparative Example 1, the slight decrease in front brightness will not influence front quality.

Regarding the size of a shielded region, i.e., a region in which a display is not seen when seen from an oblique direction, two directions can be shielded in Comparative Example 2. However, as described above, it is necessary to place louver light-shielding portions obliquely with respect to vertical and horizontal directions of the screen so as to take moire countermeasures. Thus, the shielded regions cannot be provided so as to be symmetrical horizontally or vertically. On the other hand, the display device according to the present embodiment is capable of shielding three directions as described above. In Comparative Example 1, although the size of a shielded region varies depending upon the structure of a liquid crystal panel for controlling a view angle, a large view angle and a small view angle can be switched by changing the voltage applied to a liquid crystal panel for controlling a view angle.

The light-shielding performance of the display device according to the present embodiment is more excellent than that of Comparative Example 1 in the same way as in the louver film in Comparative Example 2, in terms of the absence of temperature dependence. Further, it is necessary to take the moire countermeasures as described above in the display device in. Comparative Example 2 since it uses a louver film. However, it is not necessary to take the moire countermeasures in the display device according to the present embodiment and Comparative Example 1.

Considering the display devices based on the comparison results in FIG. 7 as a whole, the display device according to the present embodiment is considered to be more excellent than those of Comparative Examples 1, 2. More specifically, the display device according to the present embodiment can control a view angle, prevent the thickness of the display device from increasing, control a view angle symmetrical horizontally (or vertically), and further set a predetermined view angle including an oblique direction, without degrading the image quality seen from a front side, by using the view angle control film 20.

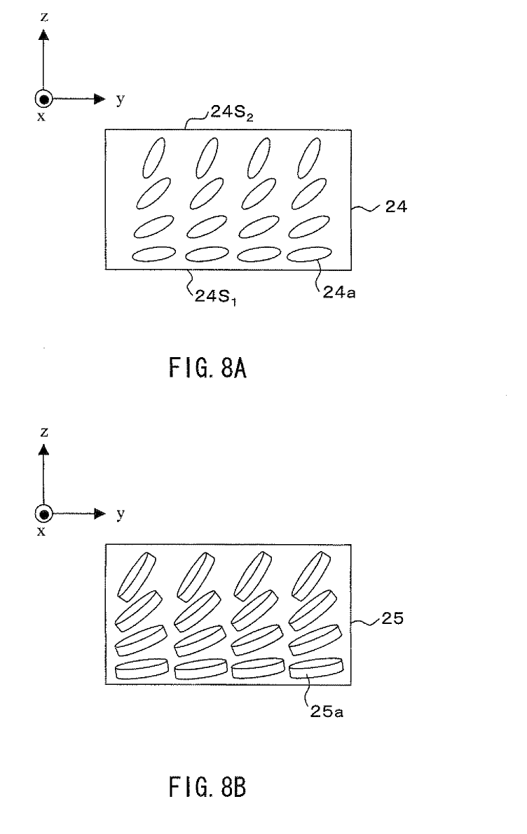

As another modified example of the above embodiment, the following configuration also is included in the embodiment of the present invention. For example, in the above embodiment, a view angle control film using the liquid crystal film 21 in which all the major axes of liquid crystal molecules are aligned so as to have the same tilt angle θ is illustrated, as shown in FIG. 3B. However, a liquid crystal film 24 shown in FIG. 8A or a liquid crystal film 25 shown in FIG. 8B may be used instead of the liquid crystal film 21.

In the liquid crystal film 24 shown in FIG. 8A, liquid crystal molecules 24a are aligned so that the tilt angle of the molecule major axes change gradually in the thickness direction (z-direction in the figure) of the film. That is, in the vicinity of one surface 24S₁ of the liquid crystal film 24, the liquid crystal molecules 24a are aligned so that the major axes thereof are substantially parallel to one surface 24S₁. On the other hand, in the vicinity of the other surface 24S₂ of the liquid crystal film 24, the liquid crystal molecules 24a are aligned so that the major axes are tilted at about 30° with respect to the normal to the surface 24S₂. That is, in the liquid crystal film 24, the liquid crystal molecules 24a have a so-called hybrid alignment state. The size of a view angle in the case of using the liquid crystal film 24 is determined substantially in accordance with the size of an average tilt angle of the liquid crystal molecules 24a.

The liquid crystal film 25 shown in FIG. 8B contains discotic liquid crystal. Liquid crystal molecules 25a of the discotic liquid crystal have a flat cylindrical shape. The liquid crystal molecules 25a of the discotic liquid crystal may be aligned so that all the molecules have the same tilt angle in the same way as in the state shown in FIG. 3B, or may have a hybrid alignment state as shown in FIG. 8B.

### Embodiment 2

A liquid crystal display device 2 according to Embodiment 2 of the present invention will be described below. The configurations having the same functions as those of the configurations described in Embodiment 1 are denoted with the same reference numerals as those therein, and the descriptions thereof will be omitted.

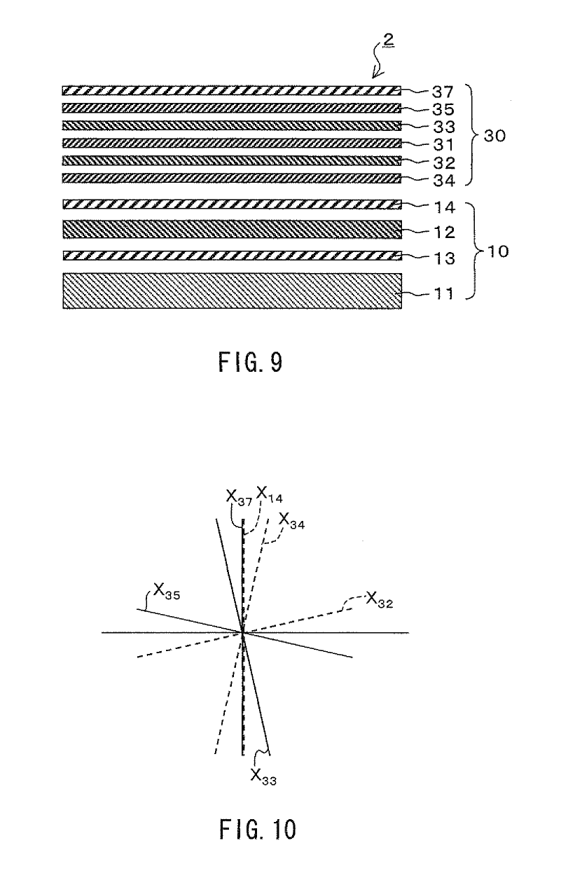

As shown in FIG. 9, the liquid crystal display device 2 according to Embodiment 2 includes a view angle control film 30 instead of the view angle control film 20 of the liquid crystal display device 1 according to Embodiment 1. The view angle control film 30 has a configuration in which λ/4 phase difference plates 32, 33, λ/2 phase difference plates 34, 35, and a linearly polarizing plate 37 are attached to each other so as to sandwich a negative C plate 31. The lamination order of these constituent members from the liquid crystal panel 10 side is as follows: the λ/2 phase difference plate 34, the λ/4 phase difference plate 32, the negative C plate 31, the λ/4 phase difference plate 33, the λ/2 phase difference pate 35, and the linearly polarizing plate 37. In this example, although the configuration including only one negative C plate 31 is illustrated, a plurality of negative C plates may be required in some cases.

The negative C plate 31 is a phase difference plate whose refractive index satisfies a relationship: nx=ny>nz. Although the λ/2 phase difference plates 34, 35 can be omitted, they should be placed between the linearly polarizing plate 14 and the λ/4 phase difference plate 32, and between the λ/4 phase difference plate 33 and the linearly polarizing plate 37, respectively, if provided.

FIG. 10 is a schematic view showing the arrangement relationship among optical axes of the constituent members in the view angle control film 30. In the example shown in FIG. 10, the linearly polarizing plates 14, 37 are placed so that polarization transmission axes X₁₄, X₃₇ thereof are parallel to each other. A delay axis X₃₄ of the λ/2 phase difference plate 34 is placed so as to form an angle α with respect to the polarization transmission axis X₁₄ of the linearly polarizing plate 14. The value of the angle α is set arbitrarily, and can be set to be, for example, about 15°. Further, a delay axis X₃₂ of the λ/4 phase difference plate 32 is placed so as to form an angle (2α+45°) with respect to the polarization transmission axis X₁₄ of the lineally polarizing plate 14. A delay axis X₃₃ of the λ/4 phase difference plate 33 is placed so as to be perpendicular to the delay axis X₃₂ of the λ/4 phase difference plate 32. A delay axis X₃₅ of the λ/2 phase difference plate 35 is placed so as to be perpendicular to the delay axis X₃₄ of the λ/2 phase difference plate 34.

Due to the above axis arrangement, if the refractive index of the negative C plate 31 is designed so that the negative C plate 31 has a phase difference of λ/2 when seen from an oblique direction (for example, at a polar angle of 45° or more), a small view angle state in which the display of the liquid crystal panel 10 cannot be identified visually from this oblique direction can be realized. This enables a small view angle state in which the display of the liquid crystal panel 10 cannot be identified visually from an oblique direction (for example, at a polar angle of 45° or more) at any azimuth angle without decreasing the brightness in the front direction and without degrading the image quality in the front direction.

In the configuration shown in FIG. 10, the linearly polarizing plate 14 and the linearly polarizing plate 37 are placed in so-called parallel-Nicols so that the polarization transmission axes X₁₄, X₃₇ thereof are parallel to each other. However, a combination of the linearly polarizing plate 37, the λ/2 phase difference plate 35, and the λ/4 phase difference plate 33 functions as a circularly polarizing plate, and a combination of the linearly polarizing plate 14, the λ/2 phase difference plate 34, and the λ/4 phase difference plate 32 also functions as a circularly polarizing plate. Therefore, the crossing angle between the polarization transmission axes X₁₄, X₃₇ of the linearly polarizing plates 14, 37 may be set arbitrarily.

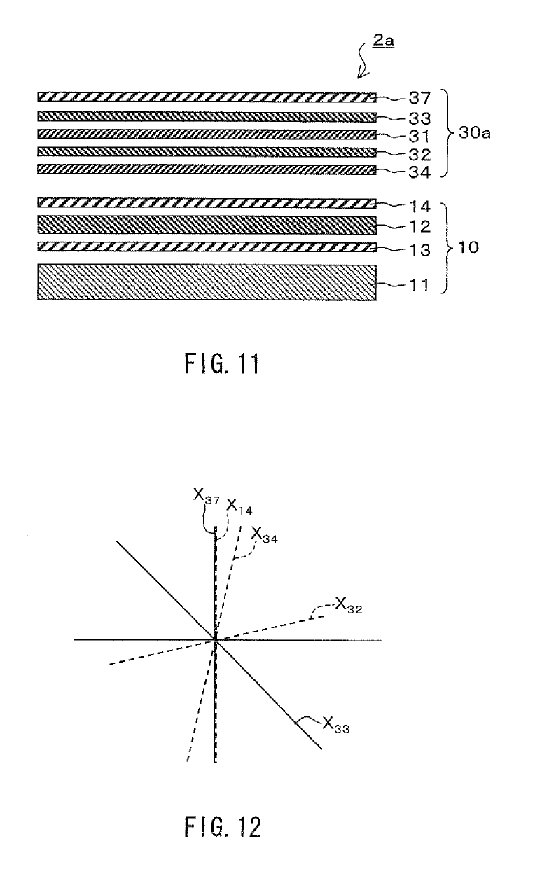

In addition to the configuration example shown in FIGS. 9 and 10, the liquid crystal display device according to the present embodiment also can be configured as follows. For example, as shown in FIG. 11, a liquid crystal display device 2a provided with a view angle control film 30a, in which the λ/2 phase difference plate 35 is omitted, also is one embodiment of the present invention. FIG. 12 is a schematic view showing the arrangement relationship among optical axes of the constituent members of the view angle control film 30a shown in FIG. 11. As shown in FIG. 12, in the view angle control film 30a, the delay axis X₃₃ of the λ/4 phase difference plate 33 is placed so as to form about 45° with respect to the polarization transmission axis X₃₇ of the linearly polarizing plate 37. In FIG. 11, although the λ/2 phase difference plate 35 is omitted from the configuration shown in FIG. 9, the λ/2 phase difference plate 34 may be omitted instead of the λ/2 phase difference plate 35. In this case, the delay axis X₃₅ of the λ/2 phase difference plate 35 may be placed as in the delay axis X₃₄ shown in FIG. 12, and the arrangement relationship between the delay axis X₃₃ of the λ/4 phase difference plate 33 and the delay axis X₃₂ of the λ/4 phase difference plate 32 may be reversed in the state shown in FIG. 12.

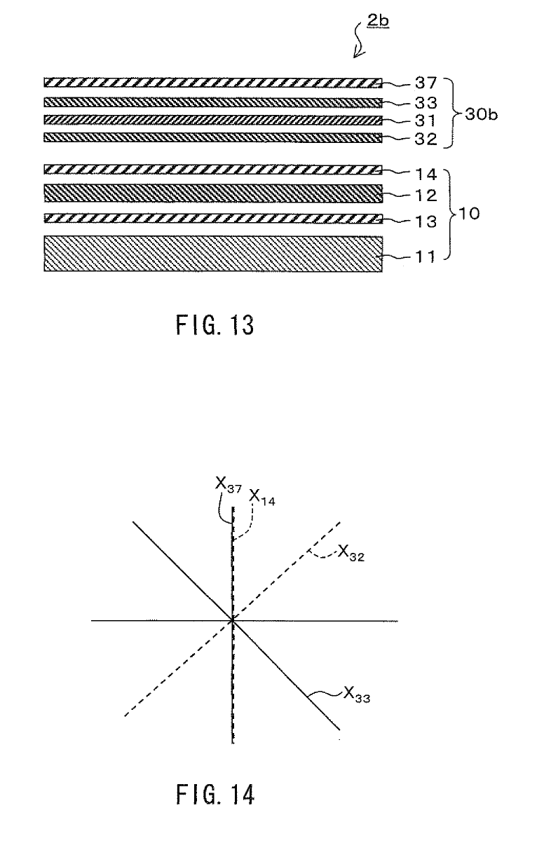

FIG. 13 is a schematic cross-sectional view showing still another configuration example of the liquid crystal display device according to the present embodiment. More specifically, as shown in FIG. 13, a liquid crystal display device 2b provided with a view angle control film 30b, in which the λ/2 phase difference plate 34 and the λ/2 phase difference plate 35 are omitted, also is one embodiment of the present invention. FIG. 14 is a schematic view showing the arrangement relationship among optical axes of the constituent members of the view angle control film 30b shown in FIG. 13. As shown in FIG. 14, in the view angle control film 30b, the delay axis X₃₂ of the λ/4 phase difference plate 32 is placed so as to form about 45° with respect to the polarization transmission axis X₁₄ of the linearly polarizing plate 14. Further, the delay axis X₃₃ of the λ/4 phase difference plate 33 is placed so as to form about 45° with respect to the polarization transmission axis X₃₇ of the linear polarizing plate 37.

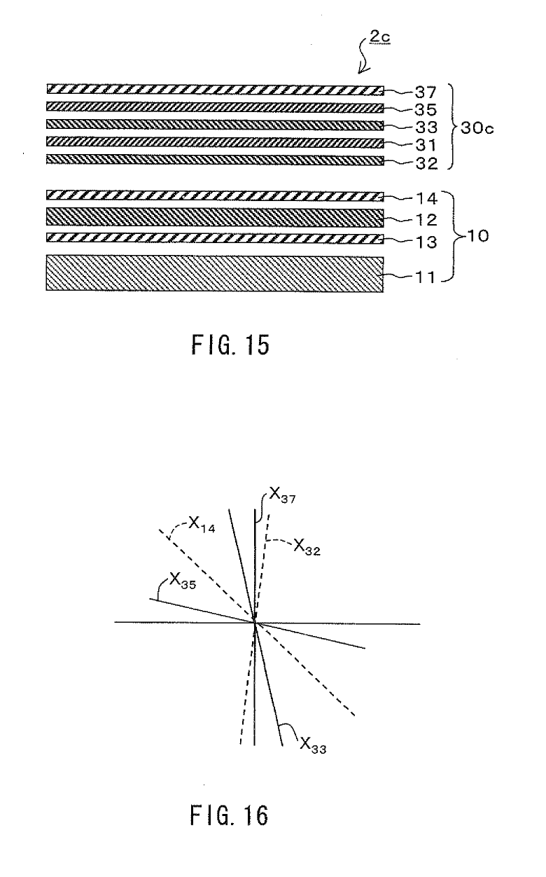

FIG. 15 is a schematic cross-sectional view showing still another configuration example of the liquid crystal display device according to the present embodiment. More specifically, as shown in FIG. 15, a liquid crystal display device 2c provided with a view angle control film 30c, in which the λ/2 phase difference plate 34 is omitted, also is one embodiment of the present invention. FIG. 16 is a schematic view showing the arrangement relationship among optical axes of the constituent members in the view angle control film 30c shown in FIG. 15. As shown in FIG. 16, in the view angle control film 30c, the linearly polarizing plates 14, 37 are placed so that the polarization transmission axes X₁₄, X₃₇ form about 45°. Further, the delay axis X₃₂ of the λ/4 phase difference plate 32 is placed so as to form about 55° with respect to the polarization transmission axis X₁₄ of the linearly polarizing plate 14. The axis arrangement of the λ/2 phase difference plate 35 and the λ/4 phase difference plate 33 with respect to the linearly polarizing plate 37 is the same as the configuration shown in FIGS. 9 and 10.

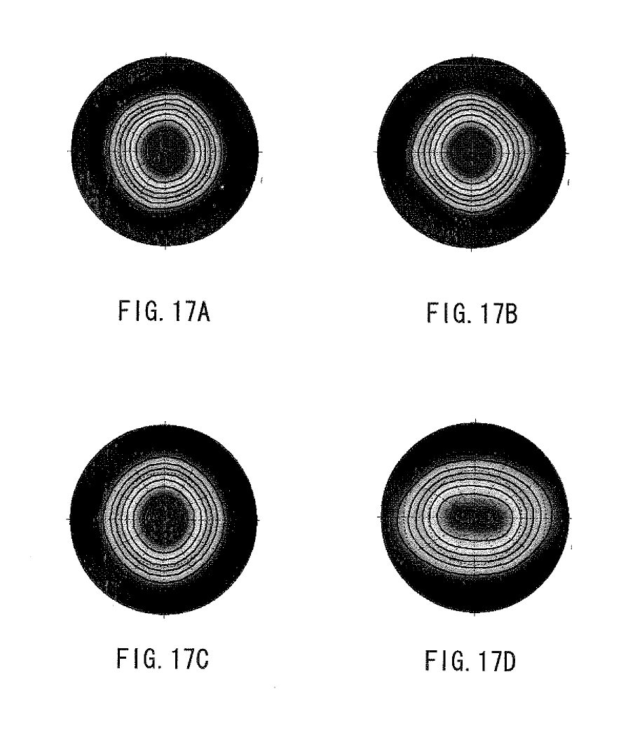

FIGS. 17A-17D are charts respectively showing the optical characteristics of the liquid crystal display devices 2, 2a, 2b, and 2c shown in FIGS. 9, 11, 13, and 15. As shown in FIG. 17A, in the liquid crystal display device 2 provided with the view angle control film 30 shown in FIGS. 9 and 10, a small view angle state can be realized in which the display of the liquid crystal panel 10 cannot be identified visually from an oblique direction (for example, at a polar angle of 45° or more) at any azimuth angle. Further, as shown in FIG. 17B, even in the liquid crystal display device 2a shown in FIGS. 11 and 12, a small view angle state can be realized in which the display of the liquid crystal panel 10 cannot be identified visually from an oblique direction (for example, at a polar angle of 45° or more) at any azimuth angle. As shown in FIG. 17C, even in the liquid crystal display device 2b shown in FIGS. 13 and 14, a small view angle state can be realized similarly. Further, as shown in FIG. 17D, in the liquid crystal display device 2c shown in FIGS. 15 and 16, a small view angle state can be realized in which the display of the liquid crystal panel 10 cannot be identified visually from an oblique direction, when seen from two directions parallel to the polarization transmission axis X₃₇ of the linearly polarizing plate 37, at any azimuth angle. In the case of the liquid crystal display device 2c, as shown in FIG. 17D, the display of the liquid crystal panel 10 can be identified visually even at a relatively large polar angle, when seen from two directions perpendicular to the polarization transmission axis X₃₇ of the linearly polarizing plate 37, at any azimuth angle.

According to the configurations shown in FIGS. 11, 12 and FIGS. 13, 14, respectively, the number of phase difference plates is reduced, so that circularly polarized light is unlikely to be obtained compared with the configuration shown in FIGS. 9 and 10. According to the configurations shown in FIGS. 9, 10, FIGS. 11, 12, and FIGS. 13, 14, respectively, a view angle can be controlled to be uniform at any azimuth angle. On the other hand, according to the configuration shown in FIGS. 15 and 16, optical characteristics take a non-uniform and distorted shape with respect to an azimuth angle as shown in FIG. 17D, depending upon the set axis angle. However, by setting an axis angle intentionally so that the optical characteristics become non-uniform with respect to an azimuth angle, the display can be identified visually in a range of a large polar angle from the horizontal direction, while the range of a polar angle in which the display can be identified visually from the vertical direction can be limited. Thus, the direction in which a view angle is limited can be biased by deforming circularly polarized light into elliptically polarized light intentionally.

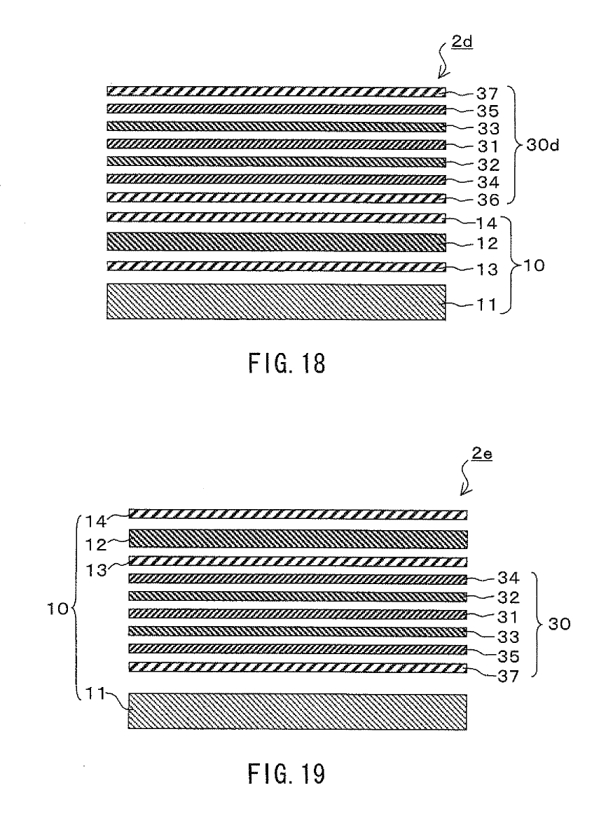

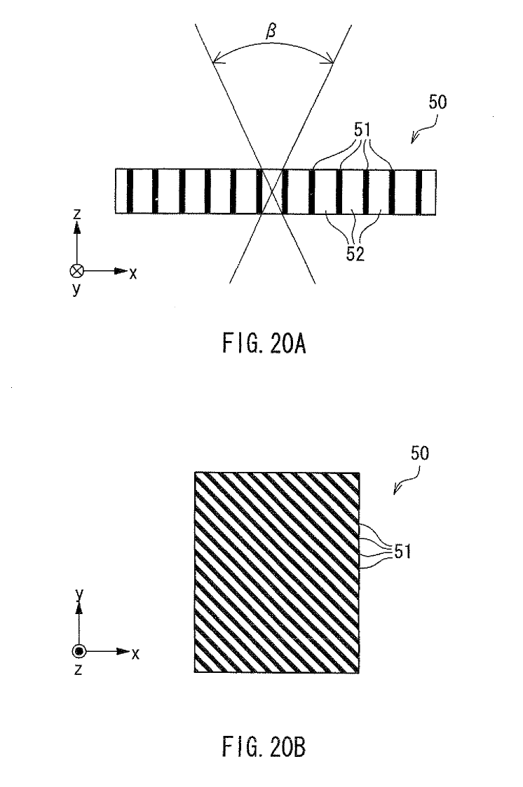

Further, the liquid crystal display device 2 of Embodiment 2 also includes liquid crystal display devices 2d, 2e shown in FIGS. 18 and 19. The liquid crystal display device 2d shown in FIG. 18 further includes a linearly polarizing plate 36 between the λ/2 phase difference plate 34 and the linearly polarizing plate 14. The liquid crystal display device 2e shown in FIG. 19 has a configuration in which the view angle control film 30 is provided on a back surface side of the liquid crystal cell 12 of the liquid crystal panel 10. In the liquid crystal display device 2e shown in FIG. 19, the view angle control film 30 is placed between the backlight 11 that is a light source of the liquid crystal panel 10 and the lineally polarizing plate 13.

Further, the configurations in which the view angle control film 30 is replaced by the above-mentioned view angle control films 30a to 30c in the liquid crystal display devices 2d, 2e shown in FIGS. 18 and 19 also are included in the embodiment of the present invention.

In the above embodiments, an example in which the view angle control film is applied to the display device has been described. In a display device in which it is desirable to prevent others from peeping from diagonally behind at all times, such as a display panel for an automatic teller (ATM), it is preferred to attach the view angle control film 20 of the present embodiment to the display panel. Further, by using the view angle control film 20 of the present embodiment to a vehicle-mounted monitor, a monitor screen can be prevented from being reflected on a windshield or side glass of a vehicle.

Further, in the above embodiments, the configuration has been described in which a liquid crystal display device is provided as an image display device. However, the display device of the present invention can be carried out as a combination of any image display device other than the liquid crystal display device and the view angle control element. For example, the present invention can be applied to but are not limited to various image display devices such as a CRT (Cathode Ray Tube), an organic EL (Electro Luminescence), an inorganic EL, a plasma display (PDP: Plasma Display Panel), a field emission display (FED: Field Emission Display), a fluorescent display tube (VFD: Vacuum Fluorescent Display), a digital micro-mirror device (DMD: Digital Micro-mirror Device), an Electrochromic display (ECD: Electrochromic Display), and an SED (Surface-conduction Electron-emitter Display).

Further, the view angle control element according to the present invention is not limited to a display device, and can be used for being attached to various articles such as a vehicle, a window glass of a building, and a partition to limit a view angle.

### INDUSTRIAL APPLICABILITY

The present invention is industrially applicable as a view angle control element capable of limiting a view angle without degrading image quality (front quality) when seen from a front side, and a display device provided with the view angle control element.

1. A display device, comprising an image display device that displays an image and a view angle control element that is laminated on the image display device and controls a view angle of the image display device,
wherein the image display device includes a linearly polarizing plate on a side of the view angle control element,
the view angle control element is a laminated film including at least a liquid crystal film, and a linearly polarizing plate laminated on a side of the liquid crystal film opposite to the linearly polarizing plate of the image display device,
in the liquid crystal film, liquid crystal molecules are solidified while being aligned with major axes thereof tilted in a predetermined azimuth angle direction from a normal direction of a surface of the liquid crystal film, and
a polarization transmission axis of the linearly polarizing plate crosses a major axis direction of the liquid crystal molecules when seen from the normal direction of the view angle control element.

2. The display device according to claim 1, wherein tilt angles of the major axes of the liquid crystal molecules are constant.

3. The display device according to claim 1, wherein the liquid crystal molecules are solidified in a hybrid alignment state.

4. The display device according to claim 1, wherein the liquid crystal is nematic liquid crystal.

5. The display device according to claim 1, wherein the liquid crystal is dichotic liquid crystal.

6. The display device according to claim 1, wherein the image display device is a transmission type or semi-transmission type liquid crystal display device having a liquid crystal layer.

7. The display device according to claim 1, wherein the view angle control element is placed on a viewer side with respect to the liquid crystal display device.

8. The display device according to claim 6, wherein the view angle control element is placed on a back surface side of a liquid crystal layer of the liquid crystal display device with respect to a viewer.

9. A display device comprising an image display device that displays an image, and a view angle control element that is laminated on the image display device and controls a view angle of the image display device,
wherein the image display device includes a linearly polarizing plate on a side of the view angle control element,
the view angle control element is a laminated film including at least:
a phase difference plate whose refractive index satisfies nx=ny>nz;
a pair of ¼ wavelength phase difference plates placed so as to sandwich the phase difference plate; and
a linearly polarizing plate that is laminated on a surface of the ¼ wavelength phase difference plate that is not opposed to the image display device among the pair of ¼ wavelength phase difference plates.

10. The display device according to claim 9, further comprising a ½ wavelength phase difference plate in at least one portion between the ¼ wavelength phase difference plate and the linearly polarizing plate.

11. A view angle control element that is laminated on an image display device having a linearly polarizing plate and controls a view angle of the image display device,
wherein the view angle control element is a laminated film including at least a liquid crystal film and a linearly polarizing plate laminated on a side of the liquid crystal film opposite to the linearly polarizing plate of the image display device,
in the liquid crystal film, liquid crystal molecules are solidified while being aligned with major axes thereof tilted in a predetermined azimuth angle direction from a normal direction of a surface of the liquid crystal film, and
a polarization transmission axis of the linearly polarizing plate crosses a major axis direction of the liquid crystal molecules when seen from the normal direction of the view angle control element.

12. A view angle control element that is laminated on an image display device having a linearly polarizing plate and controls a view angle of the image display device,
wherein the view angle control element is a laminated film including at least:
a phase difference plate whose refractive index satisfies nx=ny>nz;
a pair of ¼ wavelength phase difference plates placed so as to sandwich the phase difference plate; and
a linearly polarizing plate that is laminated on a surface of the ¼ wavelength phase difference plate that is not opposed to the image display device among the pair of ¼ wavelength phase difference plates.
